(19) United States
(12) Patent Application Publication
(10) Pub. No.: US 2006/0014000 A1
(43) Pub. Date: Jan. 19, 2006

(54) Plastic substrate and method for processing the same

(75) Inventors: Masashi Suzuki, Shinjuku-Ku (JP); Minoru Komada, Shinjuku-Ku (JP)

Correspondence Address: BURR & BROWN, PO BOX 7068, SYRACUSE, NY, 13261-7068, US

(73) Assignee: Dai Nippon Printing Co., Ltd., Shinjuku-Ku (JP)

(21) Appl. No.: 11/115,091

(22) Filed: Apr. 26, 2005

(30) Foreign Application Priority Data
Apr. 30, 2004 (JP) 2004-135101

(51) Int. Cl. B32B 23/02

(52) U.S. Cl. 428/192

(57) ABSTRACT

An objective of the present invention is to provide a heat-resistant plastic substrate, which can prevent damage such as cracking, for example, in production, a processing process, and handling, and has impact resistance, and to provide a method for processing the plastic substrate. According to the present invention, in a method for processing a sheet-like plastic substrate, a corner defined by a substrate surface and an end in the thickness-wise direction of a plastic substrate is heated and melted to form a curved surface, and the corner is processed to render the end face of the substrate perpendicular to the substrate surface and to satisfy a relationship represented by formula (I)=(0.5 to 0.9)L wherein L represents the thickness of the substrate and I represents the length of the end face. The processing of the corner defined by the surface and section of the plastic substrate to suppress the occurrence of microcracking can significantly improve the impact resistance of the substrate, and, thus, damage such as cracking of the plastic substrate can be prevented, for example, in the production, processing process, and handling.

### TECHNICAL FIELD

The present invention relates to a processing method for improving impact resistance of a plastic substrate susceptible to damage and a plastic substrate produced by said method.

### BACKGROUND ART

In recent years, thickness-reduced and weight-lightened products have been developed in various industries. Regarding familiar livingwares, heavy and easily broken glass bottles have been replaced, for example, by lightweight and highly safe films such as highly gas barrier paper packs and PET (polyethylene terephthalate) bottles. In addition, these replacements are found in many surrounding articles such as spectacle lenses and front protective glass of watches or clocks.

Further, in the field of displays as well, for example, a number of liquid crystal displays have already been replaced by plastics. At the present time, the development of larger displays is being forwarded on a larger scale than ever before. This has led to an ever-increasing importance of lightweight and unbreakable plastics as an alternative to glass which is heavy and susceptible to cracking.

Plastics have the above advantages, but on the other hand, they are inferior in thermal stability to glass. For use in displays, a high level of transparency is required. Therefore, conventional engineering plastics cannot be used. Regarding transparenet plastics, however, since Tg of even polyethylene terephthalate which is said to have a high level of heat resistance is around 70° C., polyethylene terephthalate cannot be utilized without difficulties in a process which is exposed to high-temperature heat.

Under these circumstances, in recent years, the provision of a rigid structure has led to the development of a plastic substrate that can suppress thermal expansion, is thermally stable, has chemical resistance, and has a high level of suitability for process. In such development, a plastic substrate having a heat resistance above 200° C. and having better dimensional stability has also been developed. This plastic substrate has a rigid structure and a high level of heat resistance, but on the other hand, it has a problem that the substrate is susceptible to cracking.

To overcome this problem, for example, Japanese Patent Laid-Open No. 128915/2002 proposes that at least one corner of the plastic sheet is brought to a notched form or an R corner form. This method, however, does not specify the form of the end face (thickness-wise direction) in the corner of the plastic sheet and cannot be said to be a satisfactory measure for breakage of the plastic sheet.

### SUMMARY OF THE INVENTION

An object of the present invention is to solve the above problems of the prior art and to provide a heat-resistant plastic substrate, which can prevent damage such as cracking, for example, in production, a processing process, and handling, and has impact resistance, and to provide a method for processing the plastic substrate.

The invention as defined in claim 1 is a sheet-like plastic substrate comprising a corner that is defined by a substrate surface and an end face in the thickness-wise direction of the substrate and constitutes a curved surface, said curved surface satisfying formula (I)=(0.5 to 0.9)L wherein L represents the thickness of the substrate and I represents the length of the end face, the end face of the substrate being perpendicular to the substrate surface.

The invention as defined in claim 2 is characterized in that the corner defined by the substrate surface and the end in the thickness-wise direction of the substrate as defined in claim 1 is processed in a curved surface form so as to satisfy a relational expression of r=(L−I)/2 to (L−I) wherein r represents the radius of curvature.

The invention as defined in claim 3 is a method for processing a sheet-like plastic substrate, comprising heating and melting a corner defined by a substrate surface and an end in the thickness-wise direction of a plastic substrate to form a curved surface and processing the corner to render the end face of the substrate perpendicular to the substrate surface and to satisfy a relationship represented by formula (I)=(0.5 to 0.9)L wherein L represents the thickness of the substrate and I represents the length of the end face.

The invention as defined in claim 4 is characterized in that the corner defined by the substrate surface and the end in the thickness-wise direction of the substrate as defined in claim 1 is processed in a curved surface form so as to satisfy a relational expression of r=(L−I)/2 to (L−I) wherein r represents the radius of curvature.

Regarding the plastic substrate according to the present invention, the heat-resistant plastic substrate has a rigid structure susceptible to cracking. Therefore, when a large-size sheet is cut into a desired form, a number of microcracks are likely to occur in the cutting surface. Upon the application of certain pressure to the substrate, cracking occurs with the mirocracks as the starting point. To avoid this unfavorable phenomenon, when the plastic substrate susceptible to cracking is cut, a cutting method using a laser beam is usually used. When this method is adopted, any microcrack does not stay in the section of the sheet.

Since, however, the corner defined by the surface and section of the plastic substrate is cut at right angle, when the corner is broken, as in the case of the microcracks, the breakage is causative of cracking with the breakage as the starting point. By contrast, in the present invention, in a method for processing a sheet-like plastic substrate, processing is carried out in such a manner that a corner defined by a substrate surface and an end in the thickness-wise direction of a plastic substrate is heated and melted to form a curved surface and the corner is processed to render the end face of the substrate perpendicular to the substrate surface and to satisfy a relationship represented by formula (I)=(0.5 to 0.9)L wherein L represents the thickness of the substrate and I represents the length of the end face. According to this construction, when the corner defined by the surface and section of a plastic substrate is processed to suppress the occurrence of microcracks, the impact resistance of the substrate can be significantly improved and damage such as cracking of the plastic substrate can be prevented, for example, in the production, processing process, and handling of the plastic substrate.

### BRIEF DESCRIPTION OF THE DRAWINGS

FIG. 1 is a schematic diagram showing one embodiment of the plastic substrate according to the present invention;

FIG. 2 is a schematic diagram showing an example of a plastic substrate for comparison with the plastic substrate according to the present invention;

FIG. 3 is a schematic diagram showing an example of a plastic substrate for comparison with the plastic substrate according to the present invention; and

FIG. 4 is an explanatory diagram illustrating one embodiment of the plastic substrate according to the present invention.

Description of Reference Characters

1: plastic substrate,

2: substrate surface,

3: end face of substrate (end), and

4: corner defined by substrate surface and end in the thickness-wise direction of a plastic substrate.

### DETAILED DESCRIPTION OF THE INVENTION

The plastic substrate according to the present invention and the method for processing the same will be described.

(Plastic Substrate)

The material for the plastic substrate is not particularly limited. A material prepared, for example, by polymerizing and curing a polymerizable composition containing a polymerizable monomer having two or more polymerizable functional groups in its molecule may be used as the material. However, heat-curing or photocuring resins, for example, epoxy resins (including epoxy (meth)acrylate), acrylic resins, and urethane resins (including urethane (meth)acrylate) are preferred as heat-resistant substrates having dimensional stability. The material, however, is not particularly limited to the organic resins, and materials including an inorganic material such as a silicone resin including polyorganosilsesquioxane may be used so far as they are heat-curing or photocuring resins.

The heat-curing or photocuring resin is preferably a resin produced, for example, by photopolymerizing a monomer containing a polyfunctional (meth)acrylate having two or more functional groups in its molecule. The polyfunctional (meth)acrylate having two or more functional groups in its molecule is preferably at least one bis(meth)acrylate selected from the group consisting of the following monomer A, monomer B, and monomer C. In the present invention, “(meth)acrylate” is a collective designation of acrylate and/or methacrylate.

Monomer A is a bis(meth)acrylate having an alicyclic structure, and examples thereof include bis(hydroxy)tricyclodecane diacrylate, bis(hydroxy)tricyclodecane dimethacrylate, bis(hydroxy)tricyclodecane acrylatemethacrylate, bis(hydroxy)pentacyclopentadecane diacrylate, bis(hydroxy)pentacyclopentadecane dimethacrylate, bis(hydroxy)pentacyclopentadecane acrylatemethacrylate, bis(hydroxymethyl)tricyclodecane diacrylate, bis(hydroxymethyl)tricyclodecane dimethacrylate, bis(hydroxymethyl)tricyclodecane acrylatemethacrylate, bis(hydroxymethyl)pentacyclopentadecane diacrylate, bis(hydroxymethyl)pentacyclopentadecane dimethacrylate, bis(hydroxymethyl)pentacyclopentadecane acrylatemethacrylate, bis(hydroxyethyl)tricyclodecane diacrylate, bis(hydroxyethyl)tricyclodecane dimethacrylate, and bis(hydroxyethyl)tricyclodecane acrylatemethacrylate. Two or more tricyclodecane compounds and pentacyclodecane compounds selected from the same group and/or different groups may also be used in combination.

Monomer B is a mono(meth)acrylate having an alicyclic structure, and examples thereof include bis(hydroxy)tricyclodecane monoacrylate, bis(hydroxy)tricyclodecane monomethacrylate, bis(hydroxy)pentacyclopentadecane monoacrylate, bis(hydroxy)pentacyclopentadecane monomethacrylate, bis(hydroxymethyl)tricyclodecane monoacrylate, bis(hydroxymethyl)tricyclodecane monomethacrylate, bis(hydroxymethyl)pentacyclopentadecane monoacrylate, bis(hydroxymethyl)pentacyclopentadecane monomethacrylate, bis(hydroxyethyl)tricyclodecane monoacrylate, and bis(hydroxyethyl)tricyclodecane monomethacrylate. Two or more tricyclodecane compounds and pentacyclodecane compounds selected from the same group and/or different groups may also be used in combination.

Monomer C is a mercapto compound having bi- or higher functionality, and examples thereof include pentaerythritol tetrakis(β-thiopropionate), pentaerythritol tetrakis(thioglycolate), trimethylolpropane tris(β-thiopropionate), trimethylolpropane tris(thioglycolate), ethylene glycol bis(β-thiopropionate), ethylene glycol bis(thioglycolate), diethylene glycol bis(β-thiopropionate), diethylene glycol bis(thioglycolate), triethylene glycol bis(β-thiopropionate), triethylene glycol (thioglycolate), butanediol bis(β-thiopropionate), butanediol bis(thioglycolate), dipentaerythritol hexakis (β-thiopropionate), and dipentaerythritol hexakis(thioglycolate).

Further, for example, β-thiol group-containing isocyanates such as tris[2-(β-thiopropionyloxy)ethyl]isocyanurate, thiol group-containing hydrocarbons such as benzene dimercaptan, and dimercapto compounds synthetized by a reaction of a diglycidyl compound with hydrogen sulfide may be mentioned as monomer C.

All the three monomers, monomers A, B, and C, may be used for photopolymerization and curing to prepare a photocuring resin. The present invention, however, is not limited to this only. For example, a method may be adopted in which at least one monomer is used for constituting a photocuring resin which is applied to the plastic substrate according to the present invention. A photocuring resin is prepared by shaping a photocurable monomer composition of the above-described monomers A, B, and C and applying an actinic radiation to the shaped product to cause photopolymerization and curing.

Monomers other than monomers A, B, and C as described above usable herein include methacryloyloxymethyl cyclododecane, 2,2-bis[4-(β-methacryloyloxyethoxy)phenyl]propane, 2,2-bis[4-(β-methacryloyloxyethoxy)cyclohexyl]propane, and 1 ,4-bis(methacryloyloxymethyl)cyclohexane.

In the present invention, an ionizing radiation is used as a curing energy radiation. Ionizing radiations usable herein include electromagnetic rays such as visible rays, ultraviolet rays, and X rays, or charged particle beams such as electron beams. Among them, visible rays, ultraviolet rays or electron beams are practically frequently used. In particular, when a photocurable monomer composition is cured using visible rays or ultraviolet rays, a photo(polymerization) initiator should be used which is dissociated by ultraviolet or visible rays with a wavelength of 100 to 800 nm to generate radicals.

Any conventional photo(polymerization) initiator may be used in combination with other ingredients. Representative examples thereof include 4-dimethylaminobenzoic acid, 4-dimethylaminobenzoic ester, alkoxyacetophenone, benzyl dimethyl ketal, benzophenone and benzophenone derivatives, alkyl benzoylbenzoate, bis(4-dialkylaminophenyl)ketone, benzyl and benzyl derivatives, benzoin and benzoin derivatives, benzoin alkyl ether, 2-hydroxy-2-methylpropiophenone, 1-hydroxycyclohexylphenyl ketone, thioxanthone and thioxanthone derivatives, 2,4,6-trimethylbenzoyldiphenyl phosphine oxide, 2-methyl-1-[4-(methylthio)phenyl]-2-morpholinopropane-1, and 2-benzyl-2-dimethylamino-1-(4-morpholinophenyl)-butanone-1.

Among them, one compound or a mixture of two or more compounds selected from the group consisting of 1-hydroxycyclohexylphenyl ketone, thioxanthone and thioxanthone derivatives, 2,4,6-trimethylbenzoyldiphenyl phosphine oxide, 2-methyl-1-[4-(methylthio)phenyl]-2-morpholino-1-propanone, and 2-benzyl-2-dimethylamino-1-(4-morpholinophenyl)-butan-1-one is particularly preferred because of high curability.

The amount of the photoinitiator added is suitably in the range of 0.02% by mass to 2% by mass based on 100 parts by mass of the whole monomer. A conventional photosensitizing agent may also be used in combination with the photo(polymerization) initiator. Representative examples of such photosensitizing agents include, but are not limited to, amines, ureas, sulfur-containing compounds, phosphorus-containing compounds, chlorine-containing compounds, or nitriles or other nitrogen-containing compounds. Other additives usable herein include antioxidants, ultraviolet absorbers, dyes, pigments, and fillers. For example, benzophenone, triazole or other ultraviolet absorbers may be mentioned as such additives.

(Method for Processing Plastic Substrate)

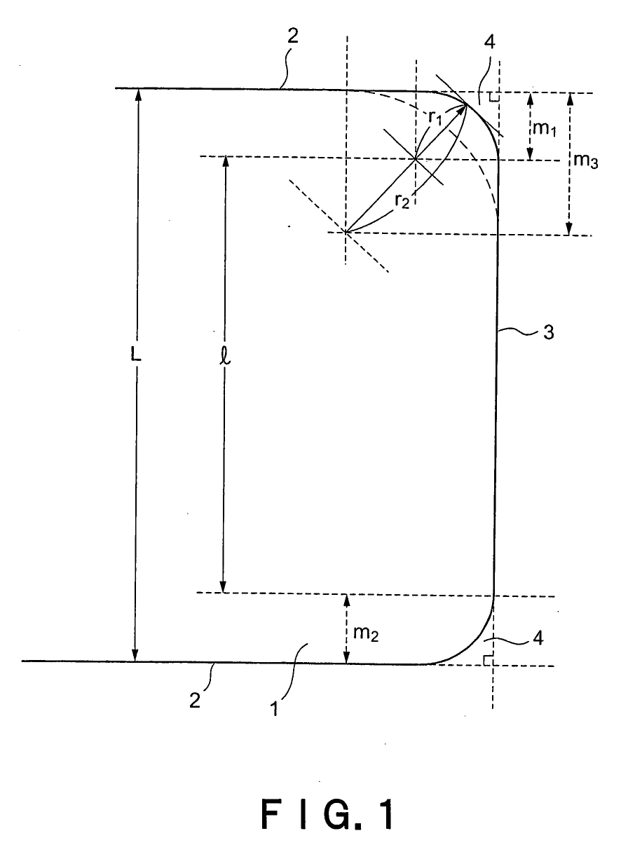

The method for processing a plastic substrate according to the present invention is characterized in that, as shown in FIG. 1, a corner 4 defined by a substrate surface 2 and an end 3 in the thickness-wise direction of a sheet-like plastic substrate 1 is heated and melted to form a curved surface and the curved surface is processed so that a substrate end face 3 is rendered perpendicular to the substrate surface 2 to satisfy a relationship represented by formula (I)=(0.5 to 0.9)L wherein L represents the thickness of the substrate and I represents the length of the end face. From the practical viewpoint, the mutual positional relationship between the substrate film thickness (L) and the end face length (I) is preferably that, in the drawing, regarding spacings m₁ and m₂, m₁ is equal to or substantially equal to m₂. The mutual positional relationship, however, is not limited to this only.

As shown in FIG. 1, in the corner 4 defined by the substrate surface 2 and the end 3 in the thickness-wise direction of the substrate 1, the corner 4 is preferably processed to form a curved surface which satisfies a relational expression of r=(L−I)/2 to (L−I) wherein r represents the radius of curvature, L represents the substrate film thickness, and I represents the length of the end face. In the relational expression, when r=(L−I)/2, m₁=m₂ and, at the same time, r₁=m₁. In the relational expression, when r=(L−I), m₃=2m₁ and, at the same time, r₂=m₃. In FIG. 1, regarding one corner 4, the relational expression of r=(L−I)/2 to (L−I) may be in a curved surface form defined by an arc extending from a curved surface with a radius of curvature r1 indicated by a solid line to a curved surface with a radius of curvature r2 indicated by a dashed line. In the relational expression of the radius of curvature r=(L−I)/2 to (L−I), when the radius of curvature r is less than (L−I)/2, the size of the curved face form of the corner is reduced. As a result, disadvantageously, the corner is likely to be chipped during handling or the like. On the other hand, when the radius of curvature r is larger than (L−I), the curved surface form of the corner is so large that, disadvantageously, the practicality of the substrate becomes unsatisfactory.

Regarding the form of the plastic substrate, the formation of a fan form, for example, R corner as shown in FIG. 1 is not always required. However, the corner should be formed in a curved surface form. Further, this curved surface is preferably formed so as to satisfy a relational expression of r=(L−I)/2 to (L−I) wherein r represents the radius of curvature, L represents the film thickness (sectional length) of the plastic substrate, and I represents the length of end face. Conversely, since upper and lower corners are processed, the length (I) of the end face becomes shorter than the substrate film thickness (L). However, the relationship represented by I=(0.5 to 0.9)L should be satisfied. When the length (I) of this end face is shorter than 0.5L, the strength of the end is lowered and, disadvantageously, the susceptability to cracking of the substrate is increased. On the other hand, when the length (I) of the end face is larger than 0.9L, disadvantageously, the corner is likely to be chipped even though the corner is processed in a curved surface form.

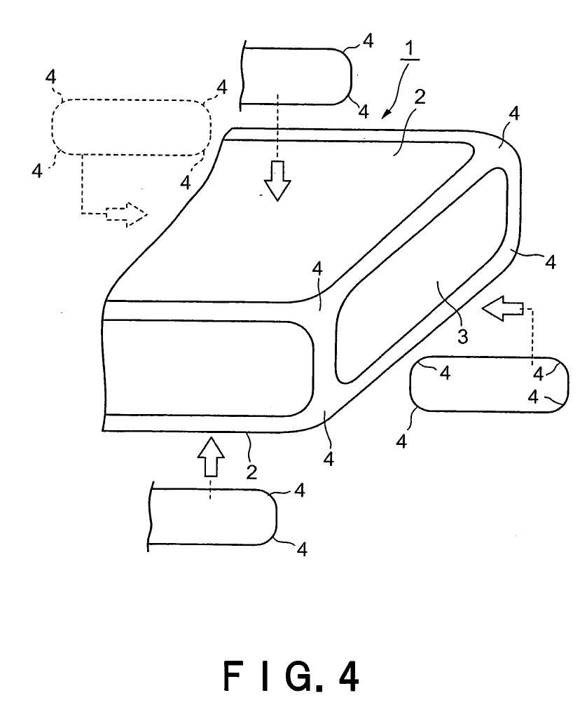

FIG. 4 is one embodiment of the plastic substrate according to the present invention. All the corners 4 in the plastic substrate 1 are in a curved surface form, and there is no angular part. When, in all of four directions indicated by arrows in the drawing, all the corners 4 are in an R form (a part of arc) to suppress the occurrence of microcracks in the corner 4 parts, the impact resistance of the substrate 1 is significantly improved and damage such as cracking of the plastic substrate 1 in the production, processing process, handling and the like can be reliably prevented. In the drawing, the corner 4 part is a part of an arc of a perfect circle. Alternatively, the corner 4 part may be an arc of an elliptical form. The plastic substrate 1 in the drawing is an explanatory view for facilitating the explanation of the corner 4 part and does not reflect the dimension of the actual whole plastic substrate.

As described above, the processing method used for forming a curved surface in the corner defined by the substrate surface and the end in the thickness-wise direction of the plastic substrate is preferably one in which the corner of the plastic substrate is heated and melted by applying a laser, for example, a carbon dioxide gas laser, an excimer laser, or a YAG laser, for molding. According to the method for processing a plastic substrate according to the present invention, the corner of a plastic substrate can be formed so that the corner defined by the surface and section of the plastic substrate is in a properly curved surface form, and, both as viewed from the substrate surface and as viewed from the section of the substrate, unlike the above-described patent document 1, the corner is not in a planar curve but in a three-dimensional curved surface form. In other words, in the corner defined by the surface and section of the plastic substrate in the present invention, any angular dotted or angular linear surface is not exposed, and the whole outer surface of the plastic substrate is in a smooth or curved surface form. By virtue of this, the occurrence of microcracks in the corner defined by the surface and section of the plastic substrate can be suppressed, the impact resistance of the substrate can be significantly improved, and damage such as cracking of the plastic substrate can be prevented in the production, processing process, handling and the like.

### EXAMPLES

### Example 1

The plastic substrate and the method for processing the plastic substrate according to the present invention will be further described with reference to the following Examples. However, it should be noted that the present invention is not limited to these Examples only unless they are not beyond the subject matter of the invention.

A plastic substrate was prepared as follows. 6 parts of pentaerythritol tetrakis(β-thiopropionate), and 0.1 part of 2,4,6-trimethylbenzoyl diphenyl phosphine oxide (“Lucirin TPO” manufactured by BASF) and 0.1 part of benzophenone as photoinitiators were stirred and mixed homogeneously in acrylate compounds of 94 parts of bis(hydroxymethyl)tricyclodecane dimethacrylate and 6 parts of bis(hydroxyl)tricyclodecane monomethacrylate, and the mixture was then defoamed to prepare a composition.

This composition was poured into a mold of optically polished glass (200 mm square) using a 0.2 mm-thick silicon sheet as a spacer. A metal halide lamp (output power 80 W/cm) was disposed above and below the mold so that the distance between the glass face and the lamp was 40 cm, and ultraviolet light was applied from the lamp for 5 min, followed by demolding. The molding thus obtained was heated at 160° C. for one hr to prepare a plastic substrate having a film thickness (L) of 200 μm. This plastic substrate was processed into a form, as shown in FIG. 1, having a substrate dimension of 90×90 mm, a substrate end face length (I)=180 μm, and a radius of curvature in corner part in thickness-wise direction (r)=10 μm, using carbon dioxide laser.

### Example 2

A plastic substrate was prepared in the same manner as in Example 1, except that the plastic substrate was processed into a form having a substrate end face length (I)=100 μm and a radius of curvature in corner part in thickness-wise direction (r)=50 μm.

### Comparative Example 1

A plastic substrate was prepared in the same manner as in Example 1, except that the corner in the thickness-wise direction of the plastic substrate was not processed. In this case, the corner defined by the substrate surface and the end face in the thickness-wise direction of the plastic substrate was not in a curved surface form but in the form of a corner of a rectangular parallelepiped.

### Comparative Example 2

A plastic substrate was prepared in the same manner as in Example 1, except that the plastic substrate was processed into a form having a substrate end face length (I)=60 μm and a radius of curvature in corner part in thickness-wise direction (r)=50 μm.

### Comparative Example 3

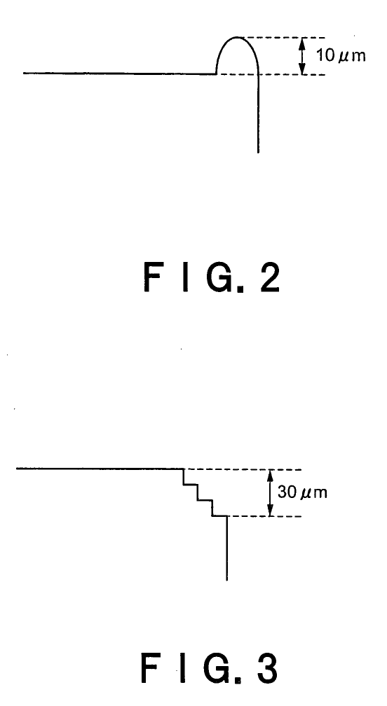

A plastic substrate was prepared in the same manner as in Example 1, except that the plastic substrate was processed into a form having a substrate end face length (I)=180 μm and the corner part in the thickness-wise direction was processed into a form shown in FIG. 2.

### Comparative Example 4

A plastic substrate was prepared in the same manner as in Example 1, except that the plastic substrate was processed into a form having a substrate end face length (I)=140 μm and the corner part in the thickness-wise direction was processed into a form shown in FIG. 3.

Testing Method

Measurement of strength . . . In order to measure the strength of a sample upon exposure to impact of the end as the corner defined by the substrate surface and the end face in the thickness-wise direction of each of the plastic substrates prepared above, 100 g of a weight was attached to the front end of a pendulum, and a sample was left to stand in a free state at a position of height=0 cm. The pendulum was brought to a predetermined height and was then released to collide with and hit the sample to determine the height of the pendulum necessary for causing cracking. For the samples, the height was compared (radius of pendulum=15 cm).

The results of evaluation are shown in Table 1.

TABLE 1

| | Height necessary for |
|---|---|
| | causing cracking, cm |
| Ex. 1 | 30 |
| Ex. 2 | 20 |
| Comp. Ex. 1 | 3 |
| Comp. Ex. 2 | 6 |
| Comp. Ex. 3 | 9 |
| Comp. Ex. 4 | 7 |

As is apparent from the results, for the samples of the Examples wherein the sheet-like plastic substrates were processed so that the corner defined by the substrate surface and the end face in the thickness-wise direction of the substrate was in a curved surface form, the length (I) of the end face relative to the substrate film thickness (L) was (0.5 to 0.9)L, and the end face of the substrate was perpendicular to the substrate surface, a significant improvement in impact resistance could be realized over the samples of the Comparative Examples which had been prepared by the processing method not satisfying the above relational expression.

### INDUSTRIAL APPLICABILITY

Examples of applications of the plastic substrate according to the present invention include, but are not particularly limited to, display substrates such as liquid crystal, organic EL, and touch panels, solar cell substrates, optical disk substrates, various lenses, and optical filters.

1. A sheet-like plastic substrate comprising a corner that is defined by a substrate surface and an end face in the thickness-wise direction of the substrate and constitutes a curved surface, said curved surface satisfying formula (I)=(0.5 to 0.9)L wherein L represents the thickness of the substrate and I represents the length of the end face, the end face of the substrate being perpendicular to the substrate surface.

2. The plastic substrate according to claim 1, wherein the corner defined by the substrate surface and the end in the thickness-wise direction of the substrate is processed in a curved surface form so as to satisfy a relational expression of r=(L−I)/2 to (L−I) wherein r represents the radius of curvature.

3. A method for processing a sheet-like plastic substrate, comprising heating and melting a corner defined by a substrate surface and an end in the thickness-wise direction of a plastic substrate to form a curved surface and processing the corner to render the end face of the substrate perpendicular to the substrate surface and to satisfy a relationship represented by formula (I)=(0.5 to 0.9)L wherein L represents the thickness of the substrate and I represents the length of the end face.

4. The method for processing a plastic substrate according to claim 3, wherein the corner defined by the substrate surface and the end in the thickness-wise direction of the substrate is processed in a curved surface form so as to satisfy a relational expression of r=(L−I)/2 to (L−I) wherein r represents the radius of curvature.
